(19) United States
(12) Patent Application Publication
(10) Pub. No.: US 2013/0253888 A1
(43) Pub. Date: Sep. 26, 2013

(54) ONE-PASS STATISTICAL COMPUTATIONS

(71) Applicants: Hung-Chih Yang, Bellevue, WA (US); Xiong Zhang, Bellevue, WA (US); Danny B. Lange, Sammamish, WA (US)

(72) Inventors: Hung-Chih Yang, Bellevue, WA (US); Xiong Zhang, Bellevue, WA (US); Danny B. Lange, Sammamish, WA (US)

(73) Assignee: MICROSOFT CORPORATION, Redmond, WA (US)

(21) Appl. No.: 13/427,626

(22) Filed: Mar. 22, 2012

(51) Int. Cl. G06F 17/10

(52) U.S. Cl. 703/2

(57) ABSTRACT

Some embodiments of the invention employ algorithms enabling the calculation of one or more statistical moments in a single pass of a dataset. For example, some embodiments may apply algorithms for calculating statistical moments to a dataset using a map-reduce framework, whereby an input dataset is partitioned into multiple shards, a separate map process is used to apply an algorithm enabling calculation of one or more statistical moments in a single scan to each shard, and one or more reduce processes consolidate the results generated by the map processes to calculate the one or more statistical moments across the entire dataset. In other embodiments of the invention, a map-reduce framework may be employed to apply algorithms enabling calculation of a covariance between data elements expressed in a dataset, instead of or in addition to one or more statistical moments.

### BACKGROUND

Descriptive statistics (e.g., mean, variance, skewness, kurtosis, etc.) may be represented as statistical moments in different degrees (e.g., variance may be represented as a second degree statistical moment, skewness as a third degree statistical moment, kurtosis as a fourth degree statistical moment, and so on). As descriptive statistics may highlight certain characteristics of a dataset, they have a wide variety of uses, including for machine learning, data mining, and data normalization.

### SUMMARY

Using conventional techniques, computing a higher-degree statistical moment (i.e., a statistical moment in the first degree or higher) of a dataset requires performing a first scan of the dataset by loading data entries in the dataset one at a time to memory to compute its mean, and then performing at least a second scan to calculate the desired statistical moment. To calculate some statistical moments, more than one additional scan of a dataset may be needed. The inventors have appreciated that employing such sequential techniques which involve multiple dataset scans can be impractical, for several reasons. For example, scanning a very large dataset (e.g., having hundreds of millions of records) multiple times expends unnecessary processor cycles.

Some embodiments of the invention apply algorithms enabling the calculation of one or more statistical moments in a single “pass” (i.e., scan) of a dataset. Using such algorithms, one or more statistical moments may be calculated for a dataset of any size, without the dataset having to be scanned multiple times. Some embodiments of the invention apply such algorithms to a dataset using a software framework known as the “map-reduce” framework. Generally, use of a map-reduce framework involves partitioning an input dataset into multiple shards, using a separate “map” process to apply a user-defined algorithm to each shard, and then using one or more “reduce” processes to consolidate the results generated by all map processes across all of the shards of the dataset. In some embodiments, each map process applies an algorithm enabling calculation of one or more statistical moments in a single scan of an input shard, and one or more reduce processes apply a recursive algorithm to calculate the statistical moments across the entire dataset. Similar techniques may be employed to compute a covariance between data elements expressed in a dataset of any size.

The foregoing is a non-limiting summary of the invention, some embodiments of which are defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram depicting an example technique for calculating statistical moments, according to the prior art;

FIG. 2 is a block diagram conceptually depicting an example technique for computing one or more statistical moments in accordance with some embodiments of the invention;

FIG. 3 is a block diagram conceptually depicting an example technique for computing covariance between data elements expressed in a dataset in accordance with some embodiments of the invention; and

FIG. 4 is a block diagram depicting an example computer with which aspects of some embodiments of the invention may be implemented.

### DETAILED DESCRIPTION

Some embodiments of the invention may employ one or more algorithms (e.g., recursive algorithms) enabling the calculation of one or more statistical moments in a single pass of a dataset. For example, some embodiments may apply recursive algorithms for calculating statistical moments to a dataset using a map-reduce framework, whereby an input dataset is partitioned into multiple shards, a separate map process is used to apply an algorithm enabling calculation of one or more statistical moments in a single scan to each shard, and one or more reduce processes consolidate the results generated by the map processes to calculate the one or more statistical moments across the entire dataset. In accordance with some embodiments of the invention, a map-reduce framework may be employed to apply algorithms enabling calculation of a covariance between data elements expressed in a dataset, instead of or in addition to statistical moments.

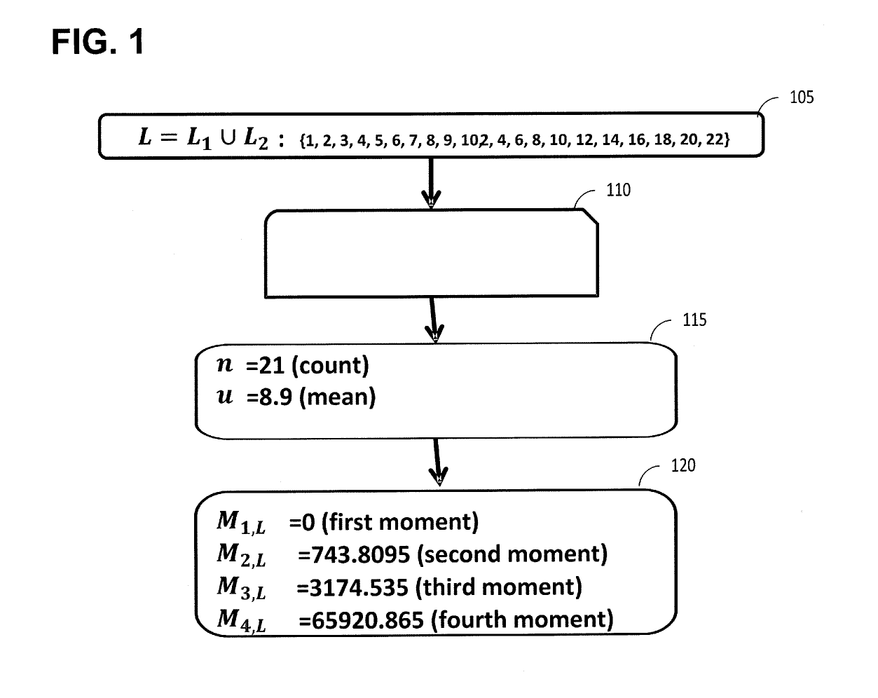

FIG. 1 illustrates an example conventional technique for computing statistical moments within a dataset. In this example, dataset L, comprising twenty-one integers, is provided as input to a process 110 for computing statistical moments. Process 110 performs a first scan of dataset L to determine that the total number of data elements in the dataset is 21, and that the mean of those elements is 8.9. One or more additional scans of dataset L is performed to calculate statistical moments. Specifically, in the example of FIG. 1, one or more additional scans of dataset L is performed to compute the variance M_{2,L} (i.e., statistical moment to the second degree), skewness M_{3,L} (i.e., statistical moment to the third degree), kurtosis M_{4,L} (i.e., statistical moment to the fourth degree), and/or any higher degree statistical moments than the examples shown.

As noted above, the technique illustrated in FIG. 1 is not susceptible to parallelization, and requires that the entirety of dataset L is be scanned multiple times. If dataset L includes hundreds of millions of records, then performing multiple scans may be unnecessarily processing- and time-intensive.

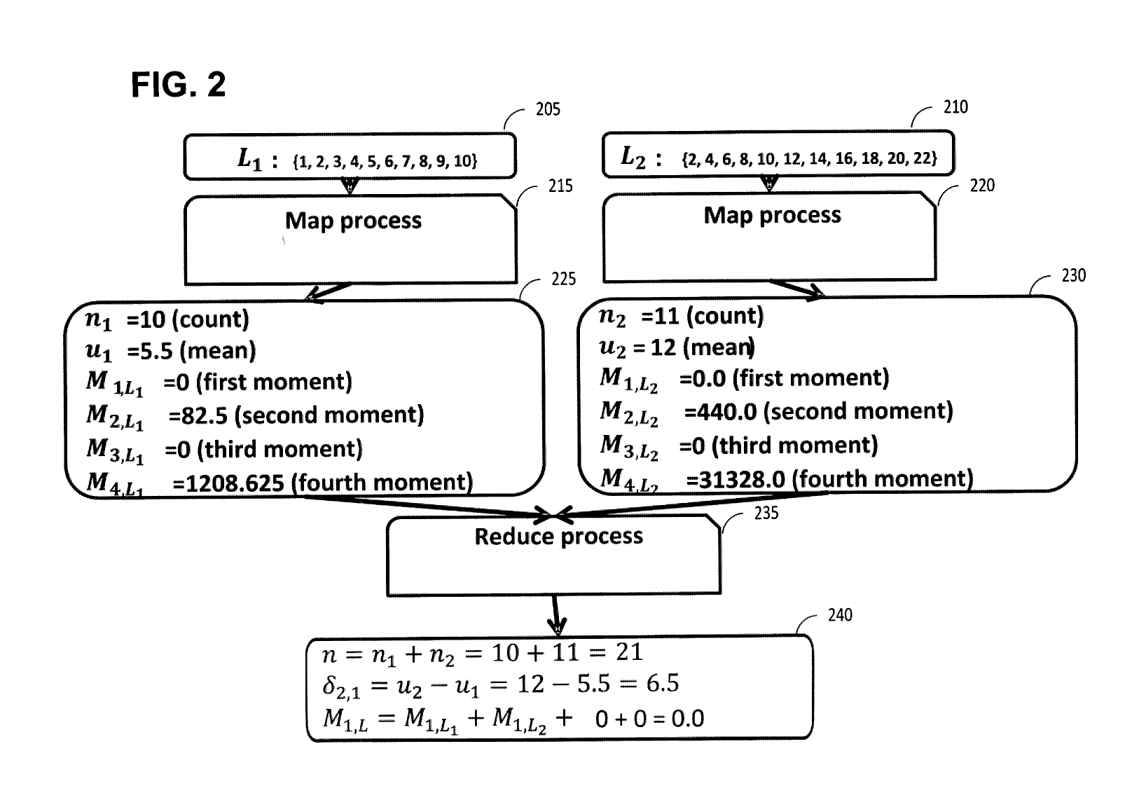

Some embodiments of the invention provide an alternative to the technique shown in FIG. 1. For example, FIG. 2 shows an example technique for calculating statistical moments in a single pass. In the example technique shown in FIG. 2, a map-reduce framework is used to apply recursive algorithms across a dataset to calculate statistical moments.

In the example depicted in FIG. 2, the dataset L of FIG. 1 is partitioned into two shards, L₁ and L₂, which are accepted as input by map processes 215, 220, respectively. It should be appreciated, however, that embodiments of the invention are not limited to partitioning a dataset into only two shards, as any suitable number of shards may be created. Further, it should be appreciated that embodiments of the invention are not limited to employing one map process per shard, or to using the same number of map processes for each shard. Any suitable number of map processes may be employed for each shard, as embodiments of the invention are not limited in this respect.

Some embodiments, each of map processes 215, 220 are executed by a different computer. However, it should be appreciated that embodiments of the invention are not limited to such an implementation, as processing may be performed in any suitable manner, using any suitable combination of processing resources. For example, a different processing node may execute each map process, and each processing node may reside on the same computer or a different computer than other processing nodes.

In the example shown, each map process calculates one or more statistical moments on its respective shard in a single pass. Specifically, in some embodiments, each of map processes 215 and 220 applies the following algorithm to compute p statistical moments for data elements x expressed in shard L:

M_{p,L}=Σ_{xεL}(x− x̅)^{p}

In the example of FIG. 2, each of map processes 215, 220 employs the above formula to determine a count n of data elements in the shard, a mean u for the shard, a first statistical moment M_{1,L} for the shard, a second statistical moment M_{2,L} for the shard, a third statistical moment M_{3,L} for the shard, and a fourth statistical moment M_{4,L} for the shard. Each of map processes 215, 220 reads all elements x in the respective shard to main memory, computes the mean R for the shard, and then calculates each statistical moment M_{p,L} in a single pass. Thus, in the example shown, map process 215 calculates for shard L₁ a count n₁ of ten, a mean u₁ of 5.5, a first statistical moment M_{1,L}_{₁} of zero, a second statistical moment M_{2,L}_{₁} of 82.5, a third statistical moment M_{3,L}_{₁} of zero, and a fourth statistical moment M_{4,L}_{₁} of 1208.625. Map process 220 calculates for shard L₂ a count n₂ of eleven, a mean u₂ of twelve, a first statistical moment M_{1,L}_{₂} of zero, a second statistical moment M_{2,L}_{₂} of 440.0, a third statistical moment M_{3,L}_{₂} of zero, and a fourth statistical moment M_{4,L}_{₂} of 31328.0. The calculation of statistical moments for data included a shard by a respective map process may be performed at least partially in parallel with calculation of statistical moments for another shard by another map process, although the invention is not limited to such an implementation.

Results 225, 230 which are generated by map processes 215, 220, respectively, are passed to reducer process 235 for application of a recursive algorithm to compute statistical moments across all of the shards. In the example shown, reduce process 235 applies a recursive algorithm to determine one or more statistical moments M_{p,L} across the entire dataset L. Specifically, reduce process 235 applies the following formula to compute statistical moment M_{p,L}:

$${M}_{p , L} = {M}_{p , {L}_{1}} + {M}_{p , {L}_{2}} + {\sum }_{k = 1}^{p - 2} ( \begin{matrix}p \\ k\end{matrix} ) [ {( - \frac{{n}_{2}}{n} )}^{k} {M}_{p - k , {L}_{1}} + {( \frac{{n}_{1}}{n} )}^{k} {M}_{p - k , {L}_{2}} ] {δ}_{2 , 1}^{k} + {( \frac{{n}_{1} {n}_{2}}{n} )}^{p} [ \frac{1}{{n}_{2}^{p - 1}} - {( \frac{- 1}{{n}_{1}} )}^{p - 1} ]$$

In the formula above, p is the order of statistical moments, L represents the dataset having two shards L₁ and L₂, M_{N}, is the p-th statistical moment for dataset L, n is the number of records in dataset L, and δ_{2,1} is the difference in mean values between L₂ and L₁.

Using this formula, reducer process 235 calculates M_{2,L} as follows:

$${M}_{2 , L} = {M}_{2 , {L}_{1}} + {M}_{2 , {L}_{2}} + {\sum }_{k = 1}^{2 - 2} ( \begin{matrix}2 \\ k\end{matrix} ) [ {( - \frac{{n}_{2}}{n} )}^{k} {M}_{2 - k , {L}_{1}} + {( \frac{{n}_{1}}{n} )}^{k} {M}_{2 - k , {L}_{2}} ] {δ}_{2 , 1}^{k} + {( \frac{{n}_{1} {n}_{2}}{n} {δ}_{2 , 1} )}^{2} [ \frac{1}{{n}_{2}^{2 - 1}} - {( \frac{- 1}{{n}_{1}} )}^{2 - 1} ]$$

$${M}_{2 , L} = {M}_{2 , {L}_{1}} + {M}_{2 , {L}_{2}} + {( \frac{{n}_{1} {n}_{2}}{n} {δ}_{2 , 1} )}^{2} [ \frac{1}{{n}_{2}} - ( \frac{- 1}{{n}_{1}} ) ] = 82.5 + 440 + ( \frac{10 * 11}{21} * {( 12 - 5.5 )}^{2} ) = 743.8095$$

Reducer process 235 calculates M_{3,L} as follows:

$${M}_{3 , L} = {M}_{3 , {L}_{1}} + {M}_{3 , {L}_{2}} + {\sum }_{k = 1}^{3 - 2} ( \begin{matrix}3 \\ k\end{matrix} ) [ {( - \frac{{n}_{2}}{n} )}^{k} {M}_{3 - k , {L}_{1}} + {( \frac{{n}_{1}}{n} )}^{k} {M}_{3 - k , {L}_{2}} ] {δ}_{2 , 1}^{k} + {( \frac{{n}_{1} {n}_{2}}{n} {δ}_{2 , 1} )}^{3} [ \frac{1}{{n}_{2}^{3 - 1}} - {( \frac{- 1}{{n}_{1}} )}^{3 - 1} ]$$

$${M}_{3 , L} = 0 + 0 + ( \begin{matrix}3 \\ 1\end{matrix} ) [ {( - \frac{{n}_{2}}{n} )}^{1} {M}_{3 - 1 , {L}_{1}} + {( \frac{{n}_{1}}{n} )}^{1} {M}_{3 - 1 , {L}_{2}} ] {δ}_{2 , 1}^{1} + {( \frac{{n}_{1} {n}_{2}}{n} {δ}_{2 , 1} )}^{3} [ \frac{1}{{n}_{2}^{3 - 1}} - {( \frac{- 1}{{n}_{1}} )}^{3 - 1} ]$$

$${M}_{3 , L} = 3 * ( - \frac{11}{21} * 82.5 + \frac{10}{21} * 440 ) * 6.5 + {( \frac{11 * 10}{21} * 6.5 )}^{3} ( \frac{1}{{11}^{2}} - \frac{1}{{10}^{2}} )$$

$${M}_{3 , L} = 3174.535$$

Reducer process 235 calculates M_{4,L} as follows:

$${M}_{4 , L} = {M}_{4 , {L}_{1}} + {M}_{4 , {L}_{2}} + {\sum }_{k = 1}^{4 - 2} ( \begin{matrix}4 \\ k\end{matrix} ) [ {( - \frac{{n}_{2}}{n} )}^{k} {M}_{4 - k , {L}_{1}} + {( \frac{{n}_{1}}{n} )}^{k} {M}_{4 - k , {L}_{2}} ] {δ}_{2 , 1}^{k} + {( \frac{{n}_{1} {n}_{2}}{n} {δ}_{2 , 1} )}^{4} [ \frac{1}{{n}_{2}^{4 - 1}} - {( \frac{- 1}{{n}_{1}} )}^{4 - 1} ]$$

$${M}_{4 , L} = 1208.625 + 31328 + ( \begin{matrix}4 \\ 1\end{matrix} ) [ {( - \frac{{n}_{2}}{n} )}^{1} {M}_{4 - 1 , {L}_{1}} + {( \frac{{n}_{1}}{n} )}^{1} {M}_{4 - 1 , {L}_{2}} ] {δ}_{2 , 1}^{1} + ( \begin{matrix}4 \\ 2\end{matrix} ) [ {( - \frac{{n}_{2}}{n} )}^{2} {M}_{4 - 2 , {L}_{1}} + {( \frac{{n}_{1}}{n} )}^{2} {M}_{4 - 2 , {L}_{2}} ] {δ}_{2 , 1}^{2} + {( \frac{{n}_{1} {n}_{2}}{n} {δ}_{2 , 1} )}^{4} [ \frac{1}{{n}_{2}^{4 - 1}} - {( \frac{- 1}{{n}_{1}} )}^{4 - 1} ]$$

$${M}_{4 , L} = 1208.625 + 31328 + 4 * ( - \frac{11}{21} * 0 + \frac{10}{21} * 0 ) * 6.5 + 6 * ( {( - \frac{11}{21} )}^{2} * 82.5 + {( \frac{10}{21} )}^{2} * 440 ) * {6.5}^{2} + {( \frac{11 * 10}{21} * 6.5 )}^{4} ( \frac{1}{{11}^{3}} - \frac{- 1}{{10}^{3}} )$$

$${M}_{4 , L} = 65920.$$

It should be appreciated that although the example technique shown in FIG. 2 employs a single reducer to consolidate results generated by multiple map processes, not all embodiments of the invention are so limited, as any suitable number of reducers may be employed. For example, reduction may proceed in stages, with a first reducer process consolidating results generated by a first set of map processes and a second reducer process consolidating results generated by a second set of map processes in a first stage, and then a third reducer process consolidating results generated by the first and second reducer processes in a second stage. Any suitable configuration and/or sequence of operations may be employed, as embodiments of the invention are not limited in this respect.

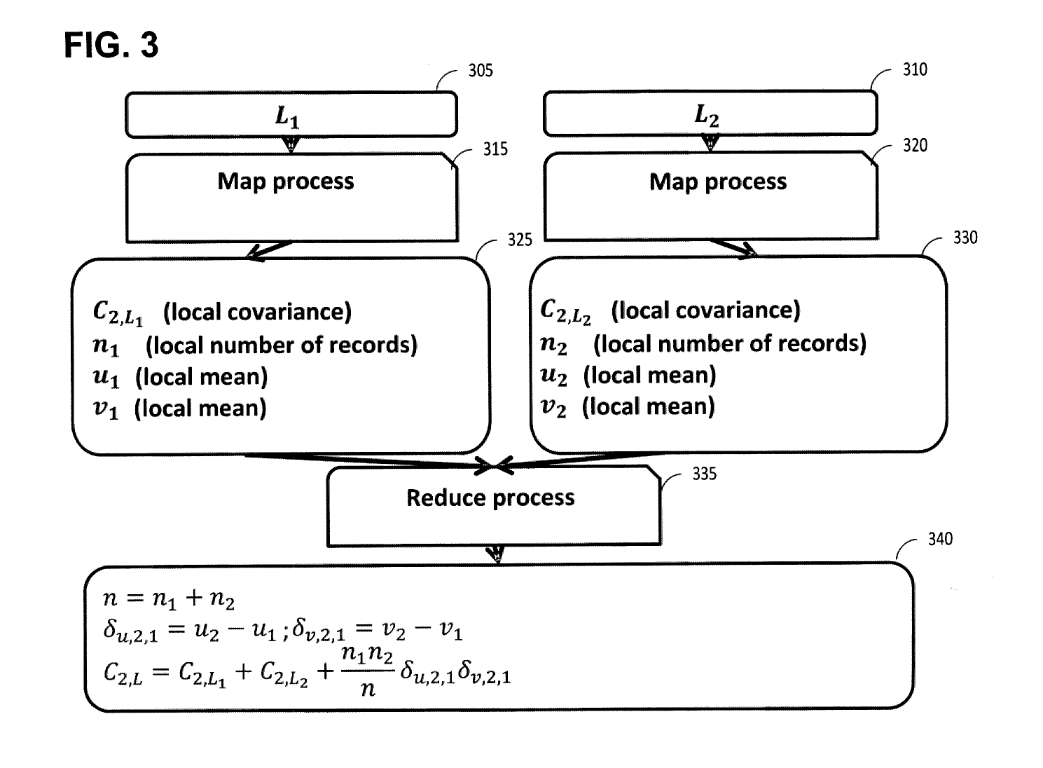

FIG. 3 depicts an example technique for calculating covariance between elements u, v expressed in each of datasets L₁ and L₂. This example technique uses a map-reduce framework wherein map processes 315, 320 corresponding to each of shards L₁ and L₂ determine a local covariance between elements u and v. Each of map processes 315, 320 may, for example, be executed by a different computer.

In some embodiments of the invention, each of map processes 315, 320 computes a local covariance C_{2,L} as follows:

C_{2,L}=Σ_{(u,v)εL}(u−ū)(v− v̅)

Thus, in the example depicted in FIG. 3, map process 315 reads all u₁, v₁ in shard L₁ in a single pass, computes means ū and v̅, and then computes covariance C_{2,L}_{₁} in memory by applying the formula immediately above. Similarly, map process 320 reads all u₂, v₂ in shard L₂ in a single pass, computes means ū and v̅, and then computes covariance C_{2,L}_{₂} in memory by applying the same formula.

It should be appreciated that although FIG. 3 depicts an example technique for computing a covariance between elements expressed in only two shards, embodiments of the invention are not so limited, as the elements for which a covariance is calculated may be expressed in any suitable number of shards and/or datasets. It should further be appreciated that embodiments of the invention are not limited to using one map process to calculate a covariance for each shard, or to using the same number of map processes for each shard. Any suitable number of map processes may be employed, as embodiments of the invention are not limited in this respect.

Reducer process 335 then applies a recursive algorithm to determine the covariance between u and v across the dataset L. In some embodiments, reducer process 335 applies the following recursive algorithm to determine covariance between u and v across the entirety of dataset L:

$${C}_{2 , L} = {C}_{2 , {L}_{1}} + {C}_{2 , {L}_{2}} + \frac{{n}_{1} {n}_{2}}{n} {δ}_{u , 2 , 1} {δ}_{v , 2 , 1}$$

In the formula above, C_{2,L}, is the covariance for dataset L, which is a set of doubles x=(u, v). δ_{u,2,1} is the difference of the mean values of the u data item between L₂ and L₁ sets, and δ_{v,2,1} is the difference of the mean values of the v data item between L₂ and L₁ sets.

As with the example technique described above with reference to FIG. 2, it should be appreciated that the example technique of FIG. 3 need not employ a single reducer process to consolidate results generated by various map processes. Any suitable number of reducers may be employed.

It should also be appreciated that although the example techniques described with reference to FIGS. 2 and 3 employ a map-reduce framework to calculate covariance in a single pass, not all embodiments of the invention are limited to such an implementation. Any one or more suitable parallelization techniques may be employed, as embodiments of the invention are not limited in this respect. If a map-reduce framework is employed, any suitable map-reduce framework (e.g., Hadoop, Cosmos/Scope, and/or other map-reduce framework) may be employed, whether now known or later developed.

It should further be appreciated that via the foregoing example techniques, embodiments of the present invention enable calculation of one or more statistical moments of a dataset, and/or of covariance between elements expressed in two or more datasets, in a single pass. As a result, embodiments of the invention may eliminate unnecessary processor cycles associated with scanning a dataset multiple times. In addition, embodiments of the invention enable parallelization of calculation operations, thereby removing limitations on the size of the dataset(s) on which the operations may be performed.

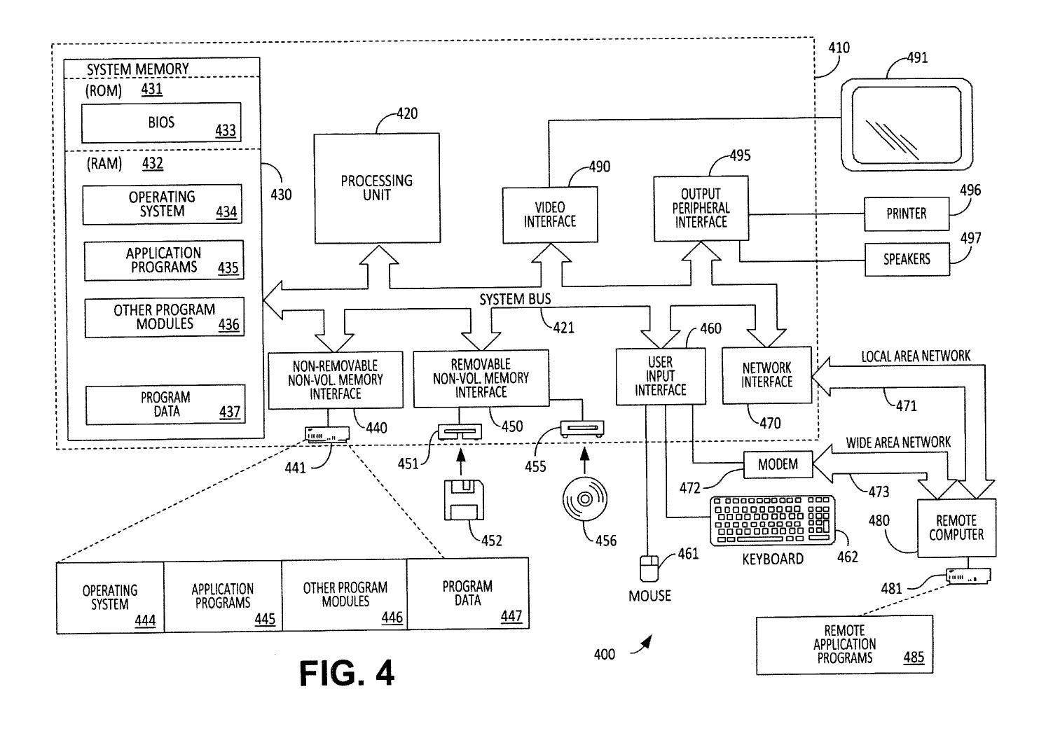

FIG. 4 illustrates an example of a suitable computing system environment 400 on which the invention may be implemented. The computing system environment 400 is only one example of a suitable computing environment and is not intended to suggest any limitation as to the scope of use or functionality of the invention. Neither should the computing environment 400 be interpreted as having any dependency or requirement relating to any one or combination of components illustrated in the exemplary operating environment 400.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 4, an exemplary system for implementing the invention includes a general purpose computing device in the form of a computer 410. Components of computer 410 may include, but are not limited to, a processing unit 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 410 typically includes a variety of computer readable media. Computer readable media can be any available media that can be accessed by computer 410 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 410. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, application programs 435, other program modules 436, and program data 437.

The computer 410 may also include other removable/non-removable, volatile/nonvolatile computer storage media. By way of example only, FIG. 4 illustrates a hard disk drive 441 that reads from or writes to non-removable, nonvolatile magnetic media, a magnetic disk drive 451 that reads from or writes to a removable, nonvolatile magnetic disk 452, and an optical disk drive 455 that reads from or writes to a removable, nonvolatile optical disk 456 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through an non-removable memory interface such as interface 440, and magnetic disk drive 451 and optical disk drive 455 are typically connected to the system bus 421 by a removable memory interface, such as interface 450.

The drives and their associated computer storage media discussed above and illustrated in FIG. 4, provide storage of computer readable instructions, data structures, program modules and other data for the computer 410. In FIG. 4, for example, hard disk drive 441 is illustrated as storing operating system 444, application programs 445, other program modules 446, and program data 447. Note that these components can either be the same as or different from operating system 434, application programs 435, other program modules 436, and program data 437. Operating system 444, application programs 445, other program modules 446, and program data 447 are given different numbers here to illustrate that, at a minimum, they are different copies. A user may enter commands and information into the computer 410 through input devices such as a keyboard 462 and pointing device 461, commonly referred to as a mouse, trackball or touch pad. Other input devices (not shown) may include a microphone, joystick, game pad, satellite dish, scanner, or the like. These and other input devices are often connected to the processing unit 420 through a user input interface 460 that is coupled to the system bus, but may be connected by other interface and bus structures, such as a parallel port, game port or a universal serial bus (USB). A monitor 491 or other type of display device is also connected to the system bus 421 via an interface, such as a video interface 490. In addition to the monitor, computers may also include other peripheral output devices such as speakers 497 and printer 496, which may be connected through a output peripheral interface 495.

The computer 410 may operate in a networked environment using logical connections to one or more remote computers, such as a remote computer 480. The remote computer 480 may be a personal computer, a server, a router, a network PC, a peer device or other common network node, and typically includes many or all of the elements described above relative to the computer 410, although only a memory storage device 481 has been illustrated in FIG. 4. The logical connections depicted in FIG. 4 include a local area network (LAN) 471 and a wide area network (WAN) 473, but may also include other networks. Such networking environments are commonplace in offices, enterprise-wide computer networks, intranets and the Internet.

When used in a LAN networking environment, the computer 410 is connected to the LAN 471 through a network interface or adapter 470. When used in a WAN networking environment, the computer 410 typically includes a modem 472 or other means for establishing communications over the WAN 473, such as the Internet. The modem 472, which may be internal or external, may be connected to the system bus 421 via the user input interface 460, or other appropriate mechanism. In a networked environment, program modules depicted relative to the computer 410, or portions thereof, may be stored in the remote memory storage device. By way of example, and not limitation, FIG. 4 illustrates remote application programs 485 as residing on memory device 481. It will be appreciated that the network connections shown are exemplary and other means of establishing a communications link between the computers may be used.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a computer-readable medium that can be considered to be a manufacture (i.e., article of manufacture) or a machine. Alternatively or additionally, the invention may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

1. A method of calculating a statistical moment of data elements expressed in a dataset, the method comprising acts of:
(A) partitioning the dataset into a plurality of shards, each shard comprising a separate subset of the data elements expressed in the dataset;
(B) separately processing each shard to calculate the statistical moment of the subset of the data elements expressed in the shard, each shard being loaded to memory only once for calculation of the statistical moment; and
(C) calculating the statistical moment of the data elements expressed in the dataset using the statistical moment of each of the plurality of shards calculated in the act (B).

2. The method of claim 1, wherein the act (C) comprises applying a recursive algorithm to calculate the statistical moment of the data elements expressed in the dataset, the recursive algorithm employing the statistical moment of each of the plurality of shards calculated in (B).

3. The method of claim 2, wherein the act (A) comprises partitioning the dataset L into two shards L₁ and L₂, and the recursive algorithm is
$${M}_{p , L} = {M}_{p , {L}_{1}} + {M}_{p , {L}_{2}} + {\sum }_{k = 1}^{p - 2} ( \begin{matrix}p \\ k\end{matrix} ) [ {( - \frac{{n}_{2}}{n} )}^{k} {M}_{p - k , {L}_{1}} + {( \frac{{n}_{1}}{n} )}^{k} {M}_{p - k , {L}_{2}} ] {δ}_{2 , 1}^{k} + {( \frac{{n}_{1} {n}_{2}}{n} )}^{p} [ \frac{1}{{n}_{2}^{p - 1}} - {( \frac{- 1}{{n}_{1}} )}^{p - 1} ]$$
where M_{p,L} is a statistical moment for L of order p, n is the number of records in dataset L, n₁ is the number of records in shard L₁, n₂ is the number of records in shard L₂, and δ_{2,1}^{k} is the difference in mean values between data elements expressed in shards L₂ and L₁.

4. The method of claim 1, wherein performing the acts (B) and (C) comprises employing a map-reduce framework, the act (B) comprising performing a map process for each shard to calculate the statistical moment for the data elements expressed in the shard, the act (C) comprising performing at least one reduce process to calculate the statistical moment for the data elements expressed in the dataset.

5. The method of claim 4, wherein the map-reduce framework comprises at least one of a Hadoop map-reduce framework and a Cosmos/Scope map-reduce framework.

6. The method of claim 4, wherein the act (C) comprises performing a single reduce process to calculate the statistical moment of the data elements expressed in the dataset.

7. The method of claim 1, wherein the act (B) comprises calculating the statistical moment for the data elements x expressed in the shard L by
$${M}_{p , L} = {\sum }_{x ∈ L} {( x - \overline{x} )}^{p}$$
where p is an order of the statistical moment.

8. At least one computer-readable storage medium encoded with instructions which, when executed, perform a method of calculating a covariance between at least two data elements expressed in a dataset, the method comprising acts of:
(A) partitioning the dataset into a plurality of shards, each shard comprising a separate subset of the dataset;
(B) separately processing each shard to calculate a covariance between the at least two data elements in the shard, each shard being loaded to memory only once to calculate the covariance; and
(C) calculating the covariance between the at least two data elements expressed in the dataset using the covariance between the at least two data elements for each of the plurality of shards calculated in the act (B).

9. The at least one computer-readable storage medium of claim 8, wherein the act (C) comprises applying a recursive algorithm to calculate the covariance between the at least two data elements in the dataset, the recursive algorithm employing the statistical moment of each of the plurality of shards calculated in the act (B).

10. The at least one computer-readable storage medium of claim 9, wherein the act (A) comprises partitioning the dataset into shards L₁ and L₂, and the recursive algorithm is
$${C}_{2 , L} = {C}_{2 , {L}_{1}} + {C}_{2 , {L}_{2}} + \frac{{n}_{1} {n}_{2}}{n} {δ}_{u , 2 , 1} {δ}_{v , 2 , 1}$$
where C_{2,L}, is the covariance between data elements u and v expressed in dataset L, δ_{u,2,1} is the difference between the mean values of the u data element between shards L₂ and L₁, and δ_{v,2,1} is the difference between the mean values of the v data element between shards L₂ and L₁.

11. The at least one computer-readable storage medium of claim 8, wherein performing the acts (B) and (C) comprises employing a map-reduce framework, the act (B) comprising performing a map process for each shard to calculate the covariance between the data elements expressed in the shard, the act (C) comprising performing at least one reduce process to calculate the covariance between the data elements expressed in the dataset.

12. The at least one computer-readable storage medium of claim 11, wherein the map-reduce framework comprises at least one of a Hadoop map-reduce framework and a Cosmos/Scope map-reduce framework.

13. The at least one computer-readable storage medium of claim 11, wherein the act (C) comprises performing a single reduce process to calculate the covariance between the data elements expressed in the dataset.

14. The at least one computer-readable storage medium of claim 8, wherein the act (B) comprises calculating the covariance C_{2,L} between the data elements u and v expressed in the shard L by
$${C}_{2 , L} = {\sum }_{( u , v ) ∈ L} ( u - \overline{u} ) ( v - \overline{v} )$$
where ū represents the mean for data element u in shard L and v̅ represents the mean for data element v in shard L.

15. A computer system for calculating a statistical moment of data elements expressed in a dataset, the dataset being partitioned into a plurality of shards, the computer system comprising a plurality of processing nodes, the plurality of processing nodes comprising first and second subsets, wherein:
the first subset of the plurality of processing nodes is programmed to separately calculate a statistical moment of data elements expressed each shard, the shard being loaded to memory only once to calculate the statistical moment;
the second subset of the plurality of processing nodes is programmed to calculate the statistical moment of the data elements expressed in the dataset using the statistical moment of each of the plurality of shards calculated by the first subset of the plurality of processing nodes.

16. The computer system of claim 15, wherein the second subset of the plurality of processing nodes is programmed to apply a recursive algorithm to calculate the statistical moment of the data elements expressed in the dataset, the recursive algorithm employing the statistical moment of each of the plurality of shards calculated by the first subset of the plurality of processing nodes.

17. The computer system of claim 16, wherein the dataset L is partitioned into shards L₁ and L₂, and the recursive algorithm is
$${M}_{p , L} = {M}_{p , {L}_{1}} + {M}_{p , {L}_{2}} + {\sum }_{k = 1}^{p - 2} ( \begin{matrix}p \\ k\end{matrix} ) [ {( - \frac{{n}_{2}}{n} )}^{k} {M}_{p - k , {L}_{1}} + {( \frac{{n}_{1}}{n} )}^{k} {M}_{p - k , {L}_{2}} ] {δ}_{2 , 1}^{k} + {( \frac{{n}_{1} {n}_{2}}{n} )}^{p} [ \frac{1}{{n}_{2}^{p - 1}} - {( \frac{- 1}{{n}_{1}} )}^{p - 1} ]$$
where M_{p,L} is a statistical moment for L of order p, n is the number of records in dataset L, n₁ is the number of records in shard L₁, n₂ is the number of records in shard L₂, and δ_{2,1} is the difference in mean values between data elements expressed in shards L₂ and L₁.

18. The computer system of claim 15, wherein the plurality of processing nodes employs a map-reduce framework, the first subset of the plurality of processing nodes performing a map process for each shard to calculate the statistical moment for the data elements expressed in the shard, the second subset of the plurality of processing nodes performing at least one reduce process to calculate the statistical moment for the data elements expressed in the dataset.

19. The computer system of claim 18, wherein the map-reduce framework comprises at least one of a Hadoop map-reduce framework and a Cosmos/Scope map-reduce framework.

20. The computer system of claim 18, wherein the second subset of the plurality of processing nodes performs a single reduce process to calculate the statistical moment of the data elements expressed in the dataset.
